(19) United States
(12) Patent Application Publication
(10) Pub. No.: US 2026/0244733 A1
(43) Pub. Date: Aug. 20, 2026

(54) Hypertext Markup Language (HTML) Sandboxing with Browser Isolation

(71) Applicant: Zscaler, Inc., San Jose, CA (US)

(72) Inventors: Sumukh Rao, Valencia (ES); Amit Jain, Santa Clara, CA (US); Deepen Desai, San Ramon, CA (US); Jithin Prajeev Nair, San Jose, CA (US); Narinder Paul, Sunnyvale, CA (US); Parnit Sainion, San Jose, CA (US); Vinay Polurouthu, Santa Clara, CA (US)

(73) Assignee: Zscaler, Inc., San Jose, CA (US)

(21) Appl. No.: 19/055,022

(22) Filed: Feb. 17, 2025

(51) Int. Cl. G06F 21/53; G06F 21/55; G06F 21/56

(52) U.S. Cl. CPC G06F 21/53; G06F 21/554; G06F 21/566

(57) ABSTRACT

Systems and methods for Hypertext Markup Language (HTML) sandboxing with browser isolation include responsive to a user attempting to access a webpage, sending the webpage to a sandbox for performing an analysis on the webpage; rendering the webpage within a browser isolation session, thereby allowing the user to interact with the webpage while the analysis is being performed; generating a score for the webpage based on the analysis, the score being indicative of the maliciousness of the webpage; and performing one or more actions based on the score associated with the webpage.

### FIELD OF THE DISCLOSURE

The present disclosure relates generally to networking and computing. More particularly, the present disclosure relates to systems and methods for Hypertext Markup Language (HTML) sandboxing with browser isolation.

### BACKGROUND OF THE DISCLOSURE

Webpage sandboxing is a security technique that isolates web content to protect users from potential threats like malicious code, unauthorized access, and data theft. By restricting what embedded elements can do, such as limiting scripts, pop-ups, and form submissions, sandboxing reduces the risk of harmful interactions with the main site or user system. However, this added security can negatively affect the user experience. Key features, such as interactive forms, media players, or auto-fill capabilities, may not function properly, leading to frustration. Inconsistent behavior across browsers, along with delays caused by restricted communication between sandboxed elements and the main page, can also disrupt the seamless experience users expect. While necessary for security, overly strict sandboxing can make websites feel less responsive and user-friendly. Based on these issues, the present disclosure presents systems and methods for HTML sandboxing with browser isolation.

### BRIEF SUMMARY OF THE DISCLOSURE

The present disclosure relates to systems and methods for Hypertext Markup Language (HTML) sandboxing with browser isolation. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include responsive to a user attempting to access a webpage, sending the webpage to a sandbox for performing an analysis on the webpage; rendering the webpage within a browser isolation session, thereby allowing the user to interact with the webpage while the analysis is being performed; generating a score for the webpage based on the analysis, the score being indicative of the maliciousness of the webpage; and performing one or more actions based on the score associated with the webpage.

The steps can further include responsive to the score indicating the webpage as being benign, the one or more actions can include ending the browser isolation session and providing the user with direct access to the webpage. Responsive to the score indicating the maliciousness of the webpage as being unknown, the one or more actions can include continuing the browser isolation session and performing additional analysis. Responsive to the score indicating the webpage as being malicious, the one or more actions can include ending the browser isolation session and blocking the webpage. The one or more actions can further include logging and labeling the webpage as being malicious for future reference. The analysis can include performing static and dynamic analysis on the webpage for determining the score while the user has access to the webpage via the browser isolation session. Sending the webpage to the sandbox and rendering the webpage within a browser isolation session can be performed concurrently.

### BRIEF DESCRIPTION OF THE DRAWINGS

The present disclosure is detailed through various drawings, where like components or steps are indicated by identical reference numbers for clarity and consistency.

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a conventional quarantine process for quarantining, scanning, blocking, and allowing a file.

FIG. 6 is a flow diagram of a smart quarantine process for quarantining, scanning, blocking, and allowing a file, where machine learning is used to front end whether or not to hold the file.

FIG. 7 is a flow diagram of a smart quarantine process for quarantining, scanning, blocking, and allowing a file, where machine learning is used to front end whether or not to hold or scan the file.

FIG. 8 is a flow diagram of a smart quarantine process for quarantining, scanning, blocking, and allowing a file, where machine learning is used to front end whether or not to hold, scan, or allow the file.

FIG. 9 is a diagram of an isolate and sandbox workflow.

FIG. 10 is a detailed diagram of an interaction between a BI systems and a sandbox.

FIG. 11 is a diagram of an interaction responsive to the sandbox sending an API response of good or bad.

FIG. 12 is a flowchart of a process for cloud sandboxing with browser isolation for immediate content access.

FIG. 13 is a flow diagram of a process for performing HTML sandboxing with Browser Isolation (BI).

FIG. 14 is a flowchart of a process for HTML sandboxing with browser isolation.

### DETAILED DESCRIPTION OF THE DISCLOSURE

Again, the present disclosure relates to systems and methods for Hypertext Markup Language (HTML) sandboxing with Browser Isolation (BI). In various embodiments, the present systems and methods include treating webpages as files in order to load the webpages in a sandbox environment. Concurrently, the webpage is loaded in a BI session in order to allow the user to interact with the webpage while the webpage is sandboxed. By doing so, while the analysis is being performed on the webpage within the sandbox, the user does not have to wait for the analysis to be completed before the webpage can be accessed. Further, for example, based on an outcome of the analysis, the systems can provide the webpage to the user outside of the BI session in order to free up BI resources and further improve the user experience for the user. The methods described herein are adapted to optimize user experience while maintaining the security of the cloud-based system and its tenants.

### § 1.0 Cybersecurity Monitoring and Protection Examples

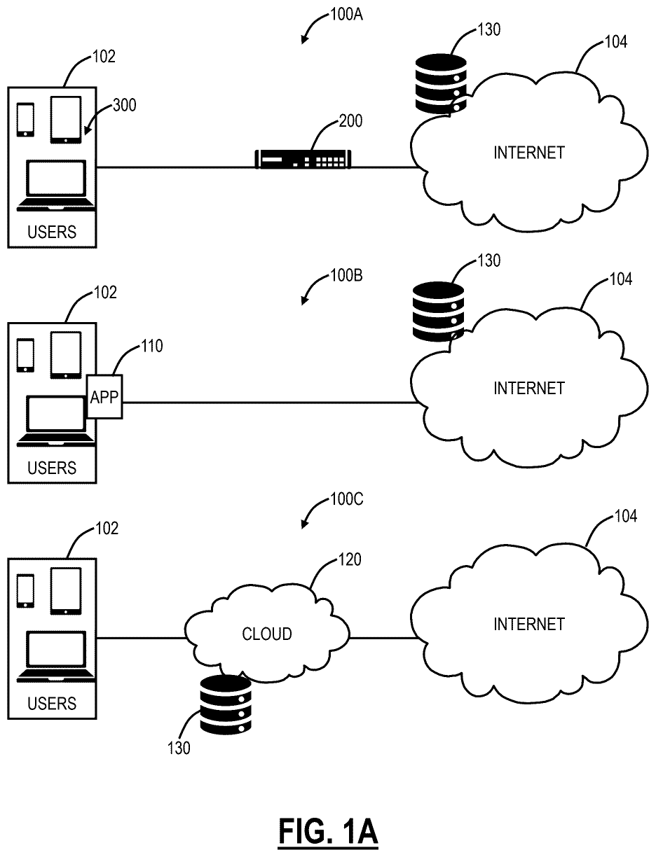

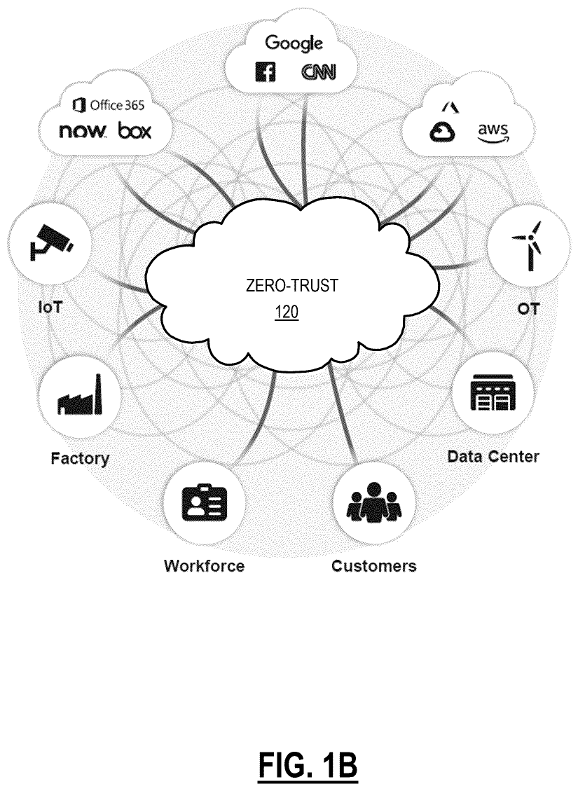

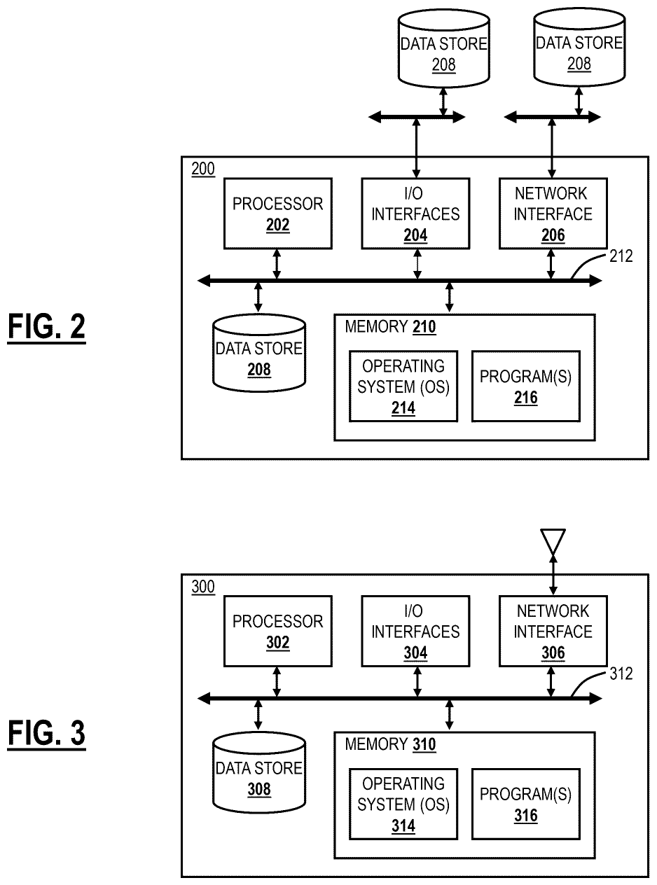

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

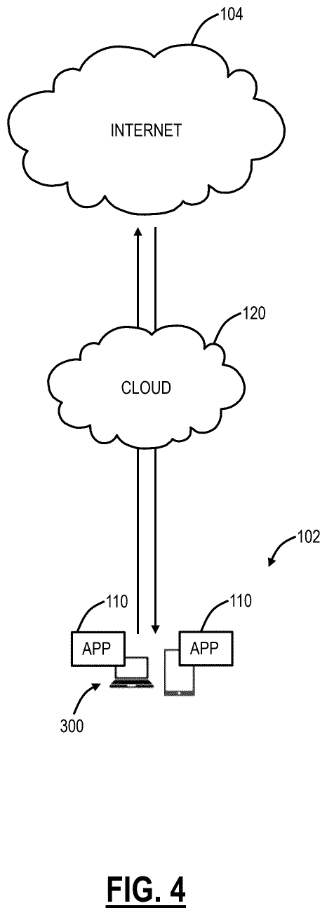

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 HTML Sandboxing

The present disclosure relates to systems and methods for HTML sandboxing for improving user experience and threat detection. HTML sandboxing is an advanced security feature designed to protect users from web-based threats by isolating and analyzing potentially malicious content in real-time. This proactive security measure is a critical component of the cloud 120 comprehensive cloud security platform, which aims to offer robust protection against a host of cyber threats. HTML sandboxing is particularly focused on safeguarding users from malicious web content embedded in HTML pages, such as scripts, links, and other elements that could potentially harm the user's device or network.

The core functionality of HTML sandboxing offered via the cloud 120 involves several sophisticated processes. Initially, all web traffic is routed through the cloud-based security platform, i.e., the cloud 120, where each HTML page and its embedded elements are meticulously inspected for signs of malicious activity. Suspicious content is then isolated in a secure, sandboxed environment that is entirely separate from the user's device, ensuring that any potential threats are effectively contained. Within this sandbox, the content is executed in a controlled manner, allowing the system to monitor its behavior for any malicious actions, such as attempts to exploit vulnerabilities, download additional malware, or exfiltrate data. This behavioral analysis is complemented by dynamic analysis, which checks for zero-day exploits and other advanced threats that may not yet be recognized by traditional signature-based detection methods.

In various embodiments, once the content has been thoroughly analyzed, the system determines its safety by assigning a score to the content. If deemed safe, the content is delivered to the user's browser without any disruption. Conversely, if the content is identified as malicious, the user is promptly notified, and the content is blocked to prevent any potential harm. Detailed reports and logs are generated for further investigation and auditing, providing valuable insights into the nature of the threats and the effectiveness of the sandboxing process.

By isolating and analyzing content in real-time, it provides an additional layer of security against web-based threats, protecting against a wide range of attacks including malware, phishing, and zero-day exploits. The process is seamless and transparent to the end-user, ensuring that users can browse the web without interruptions or performance degradation. Furthermore, as a cloud-based solution, the present systems and methods for HTML sandboxing offer comprehensive coverage, protecting all users regardless of their location or device by leveraging a global cloud 120 infrastructure. This ensures consistent security policies across the entire organization, minimizing the risk of infection from drive-by downloads and malicious websites, and helping to prevent data breaches and the loss of sensitive information.

The present systems and methods for HTML sandboxing are particularly beneficial for various use cases. In the enterprise sector, it protects employees from web-based threats while accessing corporate resources and the internet, ensuring compliance with corporate security policies and industry regulations. For remote and mobile users, it provides consistent security, safeguarding them from threats irrespective of their location and facilitating secure remote access to corporate applications and data. Additionally, in the education sector, HTML sandboxing safeguards students and faculty from malicious content while accessing online educational resources, helping to enforce safe browsing practices and compliance with educational standards.

Thus, the present systems and methods for HTML sandboxing are an essential component of modern web security, offering robust protection against an ever-evolving landscape of web-based threats. By isolating and analyzing potentially harmful content in real-time, it ensures that users can browse the web safely and securely, without compromising on performance or user experience. As part of the comprehensive cloud security platform, HTML sandboxing plays a crucial role in safeguarding organizations from cyber threats and maintaining the integrity of their digital environments. This advanced security feature not only enhances security but also provides scalability and flexibility, making it a vital tool for organizations looking to protect their users and data in an increasingly digital world.

### § 5.1 HTML Threats

Threats in files or webpages frequently manifest as malicious software, commonly known as malware. This broad category encompasses a variety of harmful programs, including viruses, worms, trojans, spyware, and ransomware. Each type of malware operates differently but shares the common goal of compromising the security and integrity of systems and data. For instance, a file may harbor harmful code that activates upon being opened. This could be an infected document that leverages software vulnerabilities to execute malicious actions, or a seemingly innocuous downloadable program embedded with hidden, harmful features.

Webpages, too, can be risky, particularly when they contain links or scripts designed to deceive users into downloading malware or disclosing personal information. These malicious elements often exploit vulnerabilities in web browsers or plugins, redirecting unsuspecting users to phishing sites designed to steal sensitive data. Even more insidiously, malicious ads or pop-ups can execute harmful code directly within the browser, compromising the user's device without requiring any explicit action on their part.

Cybercriminals are adept at disguising their threats, often masquerading malware as legitimate files or trusted websites. This deception makes it increasingly difficult for users to distinguish between safe and dangerous content, underscoring the importance of vigilance and the use of up-to-date security software. By staying informed about potential threats and employing robust security measures, individuals and organizations can better protect themselves against the ever-evolving landscape of cyber threats.

### § 6.0 Smart Quarantine

The present disclosure includes a smart quarantine approach where machine learning is utilized as a front-end to a scanning system to decide whether or not to scan a particular file. Again, the goal in such an approach is to minimize waiting time, risk, and cost. Of note, the smart quarantine approach is described herein with reference to the cloud-based system, i.e., the cloud 120, offering a cloud security service. Those skilled in the art will recognize the smart quarantine approach contemplates use in other architectures, including in a stand-along software program executed on a computing device 300, in a security appliance, in a router, in a Secure Web Gateway (SWG), in a Web proxy, etc.

### § 6.1 Conventional Quarantine Process

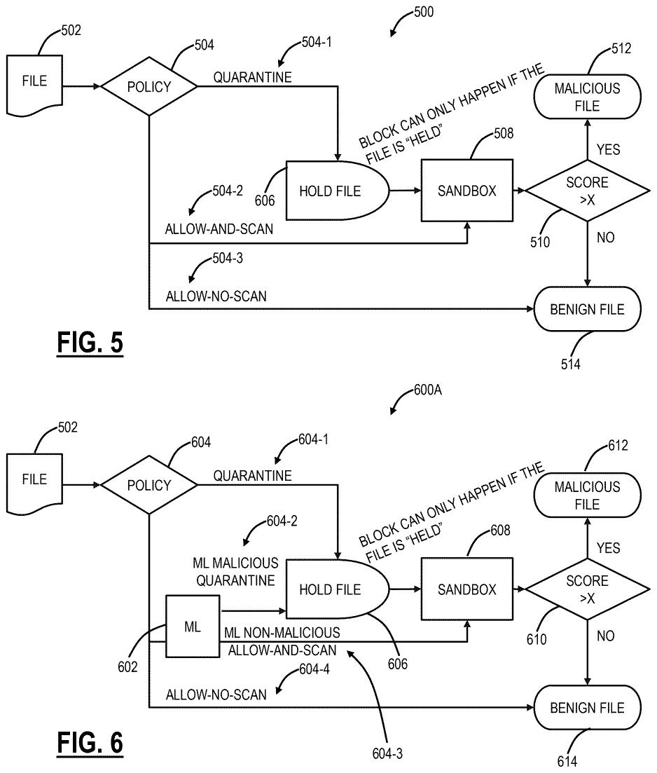

FIG. 5 is a flow diagram of a conventional quarantine process 500 for quarantining, scanning, blocking, and allowing a file 502. The file 502 can be a document (e.g., a Microsoft Office document or the like), a Portable Document Format (PDF), an executable file (e.g., a Portable Executable (P.E.) file in 32 or 64-bit format), or a webpage. The file 502 is obtained, and then policy 504 determinates how the file 502 is processed, namely either quarantined (step 504-1), allowed and scanned (step 504-2), or allowed and not scanned (step 504-3). In the cloud-based system 120, the actions of quarantine and scanning may be separate. For example, a file may be blocked to the end user 102 in the cloud-based system 120 if it is held, i.e., quarantined (step 506). The file may be allowed to the end user 102 and simultaneously scanned by a sandbox (steps 504-2, 508). The result of the sandbox 508 is a score, and it can be used to determine whether the file 502 is malicious or benign (step 510). Again, the sandbox 508 is configured to run the file 502 in a controlled environment (i.e., a “sandbox”) and perform observation and analysis to determine behavior. For example, there can be a scoring threshold, X, and a score above it means the file 502 is determined to be malicious (step 512), and a score below means the file 502 is determined to be benign (step 514).

The step 504-3 immediately allows the file 502 to the end user 102. The step 504-1 holds the file 502 (step 506), and the step 504-2 immediately allows the file 502 to the end user 102, but still performs scanning in the sandbox 508. For example, if the file 502 is malicious (step 512), but allowed at the step 504-2, the file 502 can be blocked the next time. If the file 502 is held (step 506) and the file 502 is malicious (step 512), the file 502 can be blocked, such as in the cloud-based system 120. If the file 502 is held (step 506) and found to be benign (step 514), the file 502 can be allowed to the end user 102.

### § 6.2 Machine Learning Smart Quarantining Process

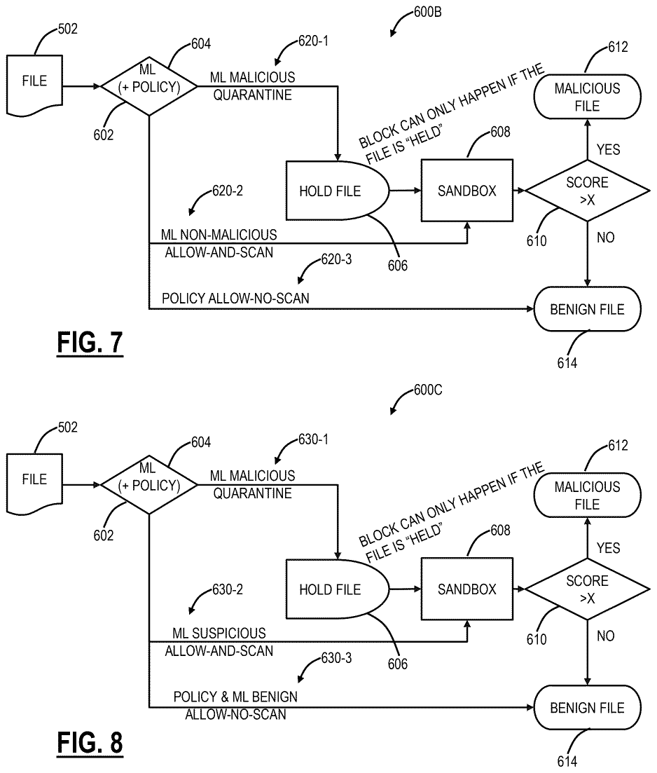

FIG. 6 is a flow diagram of a smart quarantine process 600A for quarantining, scanning, blocking, and allowing a file 502, where machine learning 602 is used to front end whether or not to hold the file 502. FIG. 7 is a flow diagram of a smart quarantine process 600B for quarantining, scanning, blocking, and allowing a file 502, where machine learning 602 is used to front end whether or not to hold or scan the file 502. FIG. 8 is a flow diagram of a smart quarantine process 600C for quarantining, scanning, blocking, and allowing a file 502, where machine learning 602 is used to front end whether or not to hold, scan, or allow the file 502.

In FIG. 6, the smart quarantine process 600A includes obtaining the file 502 and then policy 604 determinates how the file 502 is processed, either quarantined (step 604-1), processed by the machine learning 602 to determine whether to quarantine (step 604-2) or to allow and scan (step 604-3), or allowed without a scan (step 604-4). That is, in the smart quarantine process 600A, the machine learning 602 is used to front end the allow and scan step. Thus, in the smart quarantine process 600A, the allow and scan is now augmented to become quarantine if malicious from the machine learning 602 (step 604-2) or allow and scan if not malicious from the machine learning 602 (step 604-3).

Similar to the quarantine process 500, the smart quarantine process 600A includes holding the file 502 after the steps 604-1, 604-2 (step 606), and scanning the file 502 with a sandbox 608 after the steps 604-1, 604-2, 604-3. The sandbox 608 scores the file 502 (step 610), and the smart quarantine process 600A determines if the file 502 is malicious (step 612) or benign (step 614) based thereon. If the file was held (step 606), the smart quarantine process 600A can block the file 502 if malicious. Further, the smart quarantine process 600A also includes the step 604-4 of allowing without a scan based on the policy 604.

In FIG. 7, the smart quarantine process 600B includes combining the machine learning 602 with the policy 604. Here, the machine learning 602 front ends both the decision to quarantine and to allow and scan, not just the decision to allow and scan. Here, the smart quarantine process 600B can include three outputs of the combined machine learning 602 and policy 604, namely quarantine if the machine learning 602 determines the file 502 is malicious (step 620-1), allow and scan if the machine learning 602 determines the file 502 is not malicious (step 620-2), and allow without a scan if the policy 604 dictates for the file 502 (step 620-3). The remainder of the steps in the smart quarantine process 600B are the same as in the smart quarantine process 600A.

In FIG. 8, the smart quarantine process 600C also includes combining the machine learning 602 with the policy 604, but here the machine learning 602 output is used in all three decisions. The machine learning 602 front ends all the decisions, namely, quarantine if the machine learning 602 determines the file 502 is malicious (step 630-1), allow and scan if the machine learning 602 determines the file 502 is not malicious (step 630-2), and allow without a scan if the policy 604 dictates for the file 502 and if the machine learning 602 determines the file is benign (step 630-3). The remainder of the steps in the smart quarantine process 600C are the same as in the smart quarantine process 600A, 600B.

The machine learning 602 can include any of the techniques described herein. The policy 604 can be determined by a tenant associated with the user 102. For example, the policy 604 can be based on a type of the file 502, e.g., quarantine all executables, allow and scan all documents and PDFs, etc. The policy 604 can also be based on other factors such as user location, the computing device 300 types, network access technique, etc.

The smart quarantine process 600A, 600B, 600C utilizes machine learning as a front end to decide whether or not to hold the file 502 (FIG. 6), whether or not to hold or scan the file 502 (FIG. 7), and whether or not to hold, scan, or allow the file 502 (FIG. 8). The smart quarantine processes 600A, 600B, 600C address the three metrics described herein—waiting time, cost, and risk. Specifically, the conventional quarantine process 500 has a baseline for each of these metrics. The smart quarantine processes 600A, 600B, 600C improves all of these metrics relative to the conventional quarantine process 500.

The smart quarantine processes 600A reduces risk relative to the conventional quarantine process 500 by utilizing the machine learning 602 to augment and improve the allow and scan step. Allow and scan is required for some files as the users 102 simply do not want every file 502 held for the sandbox 608. Thus, allow and scan poses some risk. The machine learning 602 can reduce this risk such that some of the files 502 that would be allowed and scanned are now held based on the determination of the machine learning 602.

The smart quarantine processes 600B both reduces the risk and the waiting time relative to the conventional quarantine process 500 by utilizing the machine learning 602 to augment and improve the allow and scan step and the quarantine step. Here, the smart quarantine processes 600B provides the same benefits as the smart quarantine processes 600A for the allow and scan step. Additionally, the smart quarantine processes 600B only holds the files 502 if the output of the machine learning 602 determines the file 502 is malicious, thereby reducing the number of files 502 that are held.

Finally, the smart quarantine processes 600C reduces the waiting time, the cost, and the risk relative to the conventional quarantine process 500 by utilizing the machine learning 602 to augment and improve the allow and scan step, the quarantine step, and the allow without scan step. Again, the smart quarantine processes 600C has the same benefits as the smart quarantine processes 600A, 600B. Additionally, the smart quarantine processes 600C further augments the allow without scan only where the machine learning 602 determines the file 502 is benign. Also, the sandbox is minimized as it only handles files determined as suspicious in the machine learning 602. Thus, the smart quarantine processes 600C reduces processing costs-the sandbox only has to address suspicious files 502.

### § 7.0 Browser Isolation

Browser (web) isolation is a technique where a user's browser or apps are physically isolated away from the user device, the local network, etc. thereby removing the risks of malicious code, malware, cyberattacks, etc. This has been shown to be an effective technique for enterprises to reduce attacks. Traditionally browser isolation was focused on removing the risks of malicious code, malware, cyberattacks, etc. That is, because no data is delivered to the local system (e.g., to be processed by web content through the local web browser), none of the confidential or otherwise sensitive data can be retained on the local system.

The secure access can interoperate with browser isolation through the cloud-based system 120, to prevent data exfiltration, which is extremely critical as this is customer-facing data which adds to the sensitivity and liability, and also accessible to external users (customers). This functionality forces customers to interact with content via an isolated, contained environment.

### § 7.1 Browser Isolation for Immediate Content Access

Customers can download thousands of documents in a single business day. Administrators are forced on deciding whether to apply a “quarantine” policy, causing hours of business disruption and help desk calls by delaying file delivery, or to apply an “allow and scan” policy, which allows malware infections to take place. As a result, administrators are left with an impossible choice to either disrupt but protect the business or allow malware infections that could also damage the business.

The present disclosure provides systems and methods for cloud sandboxing with browser isolation for immediate content access. That is, while new documents, executables, etc. (content) are being sandboxed, the present systems and methods are adapted to spin up new cloud Browser Isolation (BI) sessions for immediate access to the content.

In various embodiments, when new content is detected, and the new content is unknown, the present systems are adapted to follow the sandboxing methods disclosed herein. That is, a determination can be made to sandbox the content, wherein the determination is automatic and based on the smart quarantining methods utilizing machine learning described herein. When the determination causes sandboxing of the content, a BI session is initiated allowing access to the content while sandboxing is in progress. This greatly increases user experience because the user is not required to wait for the sandboxing result. In various embodiments, once a result is determined, if the content is determined to be benign, it can be allowed to the user device. If the content (i.e., DOCX, PDF, PPT, webpage, etc.) is determined to be malicious, the systems can provide a clean PDF version of the content to the user device from the BI session.

For example, in an embodiment, an administrator can log in and configure a sandbox policy to set the action to isolate and quarantine/sandbox. A user then attempts to access an unknown file. The content can be rendered within a browser isolation session to allow the user to view the content, while the sandbox process completes in parallel. The file can be deemed benign and the original file can then be delivered to the user. If the file is deemed malicious, the user is provided the ability to download the flattened version of the rendered document. A flattened version of the content can include a flattened PDF file, the flattened PDF file being generated by the present systems. The user is not able to download the original malicious file from the isolation container. When the file is being analyzed by the sandbox, the user is able to view the file in isolation and/or is allowed to download the flattened version of the document.

In an embodiment, if configured by the administrator, a notification page stating the file has been isolated is displayed. When the sandbox verdict of benign has been reached, the user is notified and downloads the original file. When the sandbox verdict of malicious has been reached, the user is notified and an end-user notification page is shown while the original file is not available. In various embodiments, logs can be stored and queried for actions of isolating and quarantining. All relevant logs can be displayed, including the final verdicts of content.

In an embodiment, the systems and methods are adapted to sandbox password protected content. For example, a user attempting to download a password protected ZIP, RAR, or TAR file is isolated, as the files cannot be processed by the sandbox. The user is then able to open the password protected file in isolation after entering the password. The decompressed files extracted/dropped from the archive file are in the protected storage of the isolation container. Because the content has been unlocked, the files are then sent to the sandbox for analysis.

The administrator is able to configure a sandbox policy action of isolate and quarantine applying to any type of content, for example Office documents, PDF documents, etc. The configuration can also include specific types of content to trigger the isolate and quarantine action. All other file types that are not defined in the policy follow the original defined policy of the organization including quarantine or allow and scan procedures defined herein. The Administrator is further able to modify and/or create a notification displayed to the user noting the file has been isolated and sandbox analysis is taking place. The user is notified when file analysis within the sandbox has concluded and the final verdict is available. If found malicious, the isolated version of the content is refreshed to display a pre-defined end-user notification and cease displaying the malicious content. If found benign, the user is able to download the original content.

In an embodiment, while displaying the flattened version of the file, the systems can display a download option once the file has completed sandbox analysis. If the file is found to be malicious, then the user is not allowed to download the original file. If a password protected archive file is unarchived on the isolation container, the dropped files are sent to the sandbox for analysis. If the verdict is benign for all of the dropped files, then the user is able to download the individual files or the whole password protected archive file. If any of the files are found to be malicious, the password protected archive file is not downloadable. Only the dropped files which are found to be safe are allowed to be downloaded.

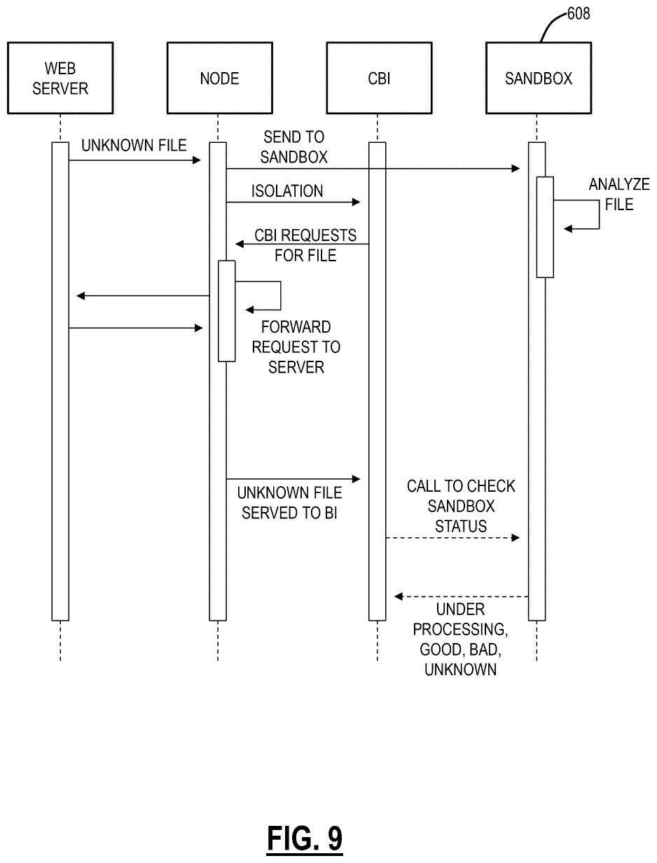

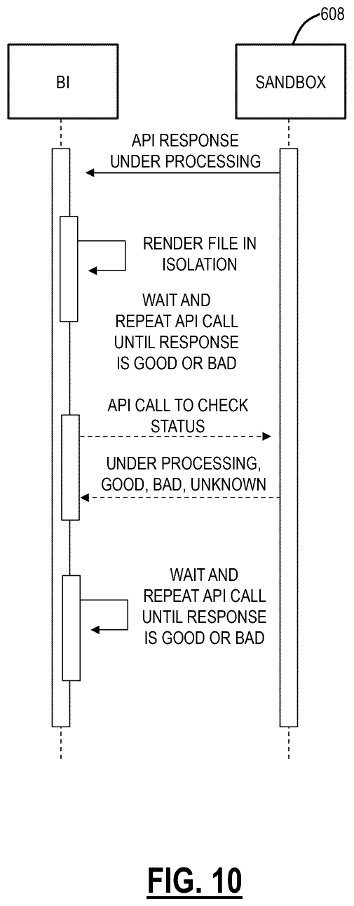

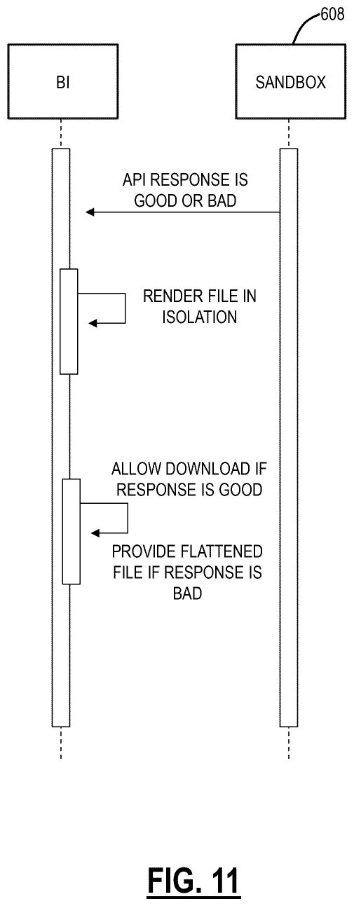

FIG. 9 is a diagram of an isolate and sandbox workflow. When a user requests an unknown file, a node of the cloud 120 sends the file to the sandbox 608. The node further initiates an isolation session with the BI systems. The BI systems request the unknown file and the node serves the file to the BI systems. The user can now view and interact with the unknown file in an isolated environment while the sandboxing process is taking place. API calls can be made to the sandbox for determining the status of the file, where the sandbox can respond by indicating the file as still being under processing, good (benign), bad (malicious), and unknown. FIG. 10 is a detailed diagram of the interaction between the BI systems and the sandbox 608. If the sandbox 608 responds to the API call stating that the content is still under processing, the content is continued to be rendered in isolation. The systems then wait and repeat the API call to check the status of the sandboxing. The time which the systems wait between API calls can be preconfigured by an administrator. This is repeated until the sandbox returns a verdict of benign or malicious. Finally, FIG. 11 is a diagram of an interaction responsive to the sandbox sending an API response of good or bad. Again, if the file is found to be malicious (bad), then the user is not allowed to download the original file, and a flattened file can be provided. Alternatively, if the response indicates the file being benign (good), then the user is allowed to download the file.

### § 7.2 Process for Browser Isolation for Immediate Content Access

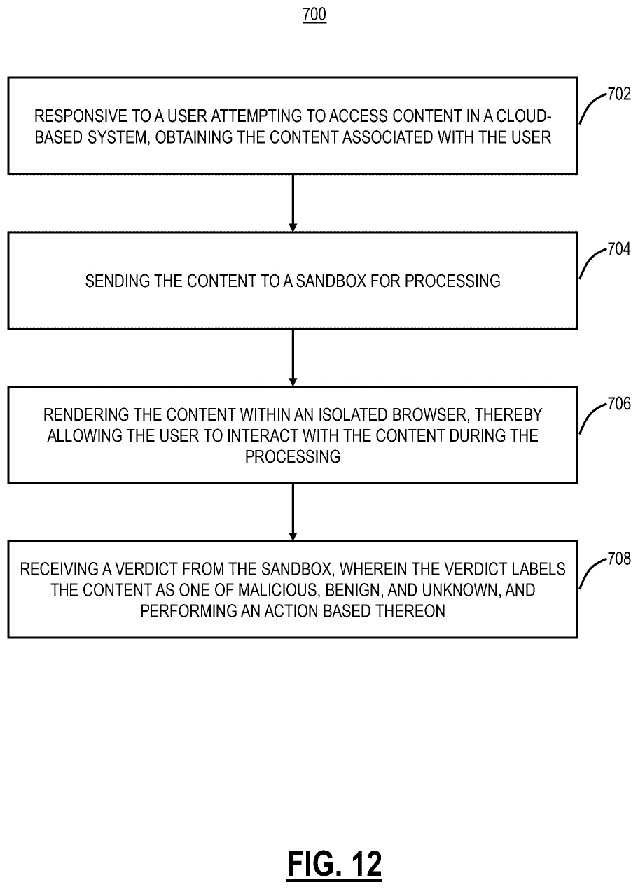

FIG. 12 is a flowchart of a process 700 for cloud sandboxing with browser isolation for immediate content access. The process 700 includes responsive to a user attempting to access content in a cloud-based system, obtaining the content associated with the user (step 702); sending the content to a sandbox for processing (step 704); rendering the content within an isolated browser, thereby allowing the user to interact with the content during the processing (step 706); and receiving a verdict from the sandbox, wherein the verdict labels the content as one of malicious, benign, and unknown, and performing an action based thereon (step 708).

The process 700 can further include utilizing a combination of policy for the user and machine learning to determine whether to send the content to the sandbox and render the content in the isolated browser. Responsive to the verdict labeling the content as benign, the steps can include allowing the user to download the content. Responsive to the verdict labeling the content as malicious, the steps can include preventing the user from downloading the content, and providing the user a flattened version of the content. The steps can further include sending an Application Programming Interface (API) call to the sandbox to check a status of the processing. The sandbox can respond to the API call by indicating that the content is still under processing, and the steps can further include waiting for a preconfigured time and repeating the API call until the sandbox responds with the verdict. The content can be password protected, and sending the content to the sandbox can be performed responsive to the user providing the password through the isolated browser. The content can be an archive file, and the steps can further include responsive to the user unarchiving the content in the isolated browser, sending dropped files to the sandbox for processing; and allowing the user to download one or more of the dropped files based on a verdict of each of the dropped files. The machine learning includes a trained machine learning ensemble model configured to determine whether the file is malicious. The obtaining can be based on inline monitoring of the user by the cloud-based system.

### § 8.0 Browser Isolation and Sandboxing

The present sandboxing methods are effective for detecting threats within files. By isolating and analyzing potentially malicious content in a controlled environment, sandboxing ensures that harmful code cannot execute on the user's device. However, one significant drawback of traditional sandboxing is its impact on user experience. Users typically do not want to wait tens of seconds or even minutes for files to be processed and deemed safe. This delay can be frustrating and disruptive, underscoring the need for solutions that enhance speed, efficiency, and overall user experience.

To address these challenges, the present systems and methods implement advanced techniques to streamline the sandboxing process and improve user satisfaction. One such technique is Browser Isolation (BI), specifically designed for loading suspicious, malicious, or unknown webpages. Unlike traditional sandboxing, which focuses on files, BI works by rendering potentially dangerous webpages in a remote environment. This means that any malicious scripts or code are executed away from the user's device, effectively neutralizing the threat without compromising browsing performance.

By serving suspicious, malicious, or unknown webpages in a BI environment, the cloud 120 ensures that users are protected without experiencing significant delays. This approach not only maintains robust security but also enhances the user experience by allowing webpages to load quickly and efficiently. Users can continue their work with minimal interruption, knowing that any potential threats are being handled securely in the background.

Various embodiments include treating webpages as files. When a webpage is treated as a file and loaded in a sandbox, the cloud 120 employs a comprehensive and multi-layered approach to determine whether the webpage is malicious. This involves several steps designed to thoroughly analyze the webpage's content, behavior, and interactions in a controlled environment. The process begins with initial inspection and isolation, where web traffic destined for the user's browser is intercepted, for example via the process 600A, 600B, and 600C, and routed to the cloud-based security platform. The webpage is then isolated in a secure sandboxed environment to ensure that any potentially harmful actions are contained and do not affect the user's device or network while the webpage is provided to the user via BI systems.

Next, the webpage undergoes static analysis, where it is scanned for known malware signatures and patterns. This step includes signature-based detection to identify already recognized threats and code inspection to examine the HTML, JavaScript, and other embedded code for suspicious elements, such as obfuscated scripts, known exploit kits, or unusual code structures. Following static analysis, dynamic behavioral analysis is conducted within the sandbox environment, allowing the webpage to behave as it would in a real browser. The system closely monitors this execution to observe any actions taken by the webpage, focusing on identifying malicious behaviors such as attempts to download additional payloads, modify system settings, exploit browser vulnerabilities, or initiate unauthorized network connections. Heuristic analysis is also employed to detect new and unknown threats by analyzing the behavior and characteristics of the webpage, including checking for exploit attempts, suspicious redirects, or code injection. Again, this in depth analysis is performed in parallel while the user has access to the webpage via the BI systems. By doing so, the user does not have to wait for the sandboxing to be completed in order to interact with the webpage in question.

Network and interaction analysis further enhance the detection process. The sandbox tracks any outbound network connections initiated by the webpage to identify if it is trying to communicate with known malicious servers or command-and-control centers. In various embodiments, the sandboxes also simulate user interactions, such as mouse movements and clicks, to trigger any hidden or conditional malware that only activates upon user action. Threat intelligence integration plays a crucial role, incorporating insights from global threat intelligence feeds to provide real-time data on emerging threats and malicious domains, enhancing the accuracy of the detection process. Reputation services are used to check the domain and URL reputation against a database of known malicious sites, quickly identifying if the webpage is associated with phishing, malware distribution, or other malicious activities.

Machine Learning (ML) and Artificial Intelligence (AI) analysis are pivotal to the cloud-based system (cloud 120) methodology. Advanced ML models are adapted to detect anomalies and patterns indicative of malicious activity, continuously learning and adapting to new threats. Predictive analysis through AI models helps identify sophisticated attacks that might not be immediately apparent through traditional analysis methods. After thorough analysis, the sandbox generates a verdict on the webpage's safety. This verdict can include a score indicative of the webpage's maliciousness. That is, the score can be between 0-100, where a higher score indicates higher risk for maliciousness. If the webpage is deemed safe, it is delivered to the user's browser, and the user can continue interacting with the webpage outside of the BI system. If malicious activity is detected, the webpage is blocked, and the user is notified. Comprehensive reports documenting the findings and behaviors observed during the analysis are created, providing valuable insights for further investigation and refining security policies.

When analyzing the security of webpages, the cloud 120 can treat the Browser Isolation (BI) session, where the webpage is loaded in a secure container and served as pixels, as the sandbox itself. This innovative approach allows the cloud 120 to leverage the strengths of sandboxing while ensuring a seamless user experience.

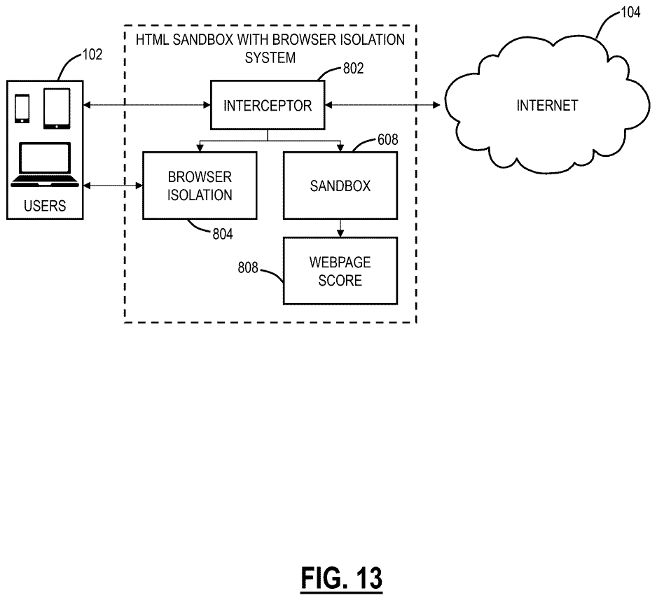

FIG. 13 is a flow diagram of a process for performing HTML sandboxing with Browser Isolation (BI). The example process displays how treating the BI session as a sandbox works to determine if a webpage is malicious while maintaining the user experience. Various embodiments include the following steps.

### Initial Setup and Traffic Interception:

In this model, the BI session begins with the interception of web traffic destined for the user's browser. This interception can be via the interceptor 802. After interception, the webpage is routed to the secure cloud-based platform. Instead of being loaded directly on the user's device, the webpage is rendered in a remote, secure container.

### Content Isolation and Execution:

The securely isolated BI environment 804 acts as a virtual sandbox. As the webpage is loaded, it is executed within this remote container. The content is rendered and processed away from the user's device, ensuring that any potentially harmful actions are contained within the secure environment and do not affect the user's local system or network.

### Static and Dynamic Analysis:

During the BI session, the webpage undergoes both static and dynamic analysis as described herein within the sandbox 608. Again, this analysis is performed while the user has access to the webpage through the BI environment 804.

### Action Performance:

Based on the score 808 determined for a particular webpage, the present systems can perform one or more actions. These actions can include continuing the isolation session or blocking the webpage responsive to the score indicating the webpage as being malicious, and providing the user with full access to the webpage outside of isolation responsive to the score indicating the webpage is benign. By ending a BI session responsive to the analysis resulting in a score indicative of the webpage being benign, the cloud 120 can save resources for actual risky connections.

In various embodiments, the actions can be performed based on various thresholds of the score. That is, responsive to the score being low, i.e., indicating that the webpage is benign, for example a score of 0-33, the systems can provide the actual webpage to the user's device outside of BI. Responsive to the score being intermediate, i.e., indicating that the maliciousness of the webpage is unknown, for example a score of 34-66, the systems can continue the BI session and perform additional analysis. Finally, responsive to the score being high, i.e., indicating that the webpage is malicious, for example a score of 67-100, the systems can block the webpage, end the BI session, and log the webpage as a malicious webpage for future reference.

The following highlights various use cases where the present systems can be implemented.

Handling malicious or suspicious obfuscated JavaScripts: Currently, cloud-based systems face challenges when dealing with certain types of obfuscated JavaScripts that cannot be matched with signatures during inline scanning. To address this, JavaScripts executed on the isolated browser can be forwarded to the sandbox out-of-band for in-depth analysis. The sandbox can analyze these scripts, and based on the results, the user can be permitted to perform further actions. Additionally, a report similar to the file sandbox can be generated to provide customers with enhanced visibility into the detected threats and actions taken.

Phishing protection: The cloud 120 infrastructure currently employs a phishing catch process that crawls webpages offline to identify phishing sites. This process can be integrated with isolated browsers or containers, allowing any webpage loaded in isolation to be subjected to phishing detection in real-time. When a webpage is loaded on the isolated browser, it undergoes inline analysis to determine if it is a phishing site. If the analysis confirms a positive result, the system can limit user interactions with the webpage, such as restricting keystrokes, preventing uploads, and the like, thereby protecting the user from potential phishing attacks.

Browser exploit detection: The cloud 120 can detect webpages that attempt to exploit browser vulnerabilities or potentially crash the isolated browser based on specific signatures and behaviors. These detected events can then be forwarded to security services for further protection and logging. This integration enriches threat intelligence, ensuring that potential browser exploits are identified and mitigated, thereby enhancing overall security and providing detailed insights into the nature and frequency of such threats.

Based on these features, the cloud 120 effectively combines the benefits of sandboxing with the advantages of BI. This approach ensures that webpages are securely rendered and analyzed in a remote environment, providing robust protection against web-based threats while maintaining an optimal user experience. The BI environment acts as both a secure container and an advanced analysis platform, ensuring that any malicious activity is detected and contained before it can impact the user. This innovative strategy highlights the commitment to balancing stringent security measures with seamless and efficient user interactions.

Moreover, treating BI sessions as a sandbox offers a range of significant benefits, enhancing both security and user experience. Visibility is crucial in demonstrating the effectiveness of such systems. By treating BI sessions this way, organizations can monitor and showcase how these sessions are actively working to detect and mitigate threats. This transparency is vital for justifying the use of BI, especially since it can be perceived as slightly intrusive and slower compared to traditional browsing experiences. Detailed reports and analytics generated from BI sessions can highlight real threats that were intercepted and neutralized, underscoring the value of the BI approach. For instance, reports including metrics such as the number of blocked malware attempts, phishing sites intercepted, and malicious scripts contained can be generated and presented to stakeholders. This visibility not only proves the usefulness of BI but also builds trust and confidence among users and decision-makers that the BI system is an essential part of the organization's cybersecurity strategy.

Further, treating BI sessions as a sandbox significantly enhances threat intelligence capabilities. By isolating and analyzing web content in real-time, the cloud 120 can capture and identify new zero-day exploits and emerging malicious techniques immediately. This proactive approach allows for the rapid detection and understanding of novel threats as they occur. Once a new malicious technique is detected, the information can be swiftly disseminated throughout the cloud's 120 infrastructure, enabling instant remediation and protection for all users. This continuous learning and updating mechanism ensures that the entire network benefits from the latest threat intelligence, bolstering defenses against sophisticated attacks. Moreover, the ability to capture and analyze cutting-edge threats helps in refining and evolving security policies, making the entire system more resilient over time.

While BI sessions provide a high level of security, they can be resource-intensive and might not always offer the most user-friendly experience. By treating BI sessions as a sandbox, the cloud 120 can optimize the isolation process to balance security with user convenience. For example, if a webpage initially flagged as suspicious is later cleared after thorough analysis, the system can transition the user from the isolated session back to a live session seamlessly in real-time. This dynamic switching not only conserves resources but also enhances the user experience by reducing the latency associated with BI sessions. Additionally, by continuously learning from the sandboxed BI sessions, the cloud 120 can refine its criteria for isolation, ensuring that only genuinely suspicious or high-risk webpages are subjected to BI. This optimization reduces unnecessary isolation, making the overall system more efficient and user-friendly.

Based thereon, treating BI sessions as a sandbox offers multiple benefits that extend beyond just enhancing security. It provides crucial visibility into the effectiveness of BI, demonstrating its value in catching real threats and thereby justifying its use. The approach also significantly boosts threat intelligence capabilities, enabling rapid detection and dissemination of information about new zero-day exploits and malicious techniques. Furthermore, it allows for the optimization of future isolation processes, striking a balance between robust security and a seamless user experience.

### § 8.1 Browser Isolation and Sandboxing Process

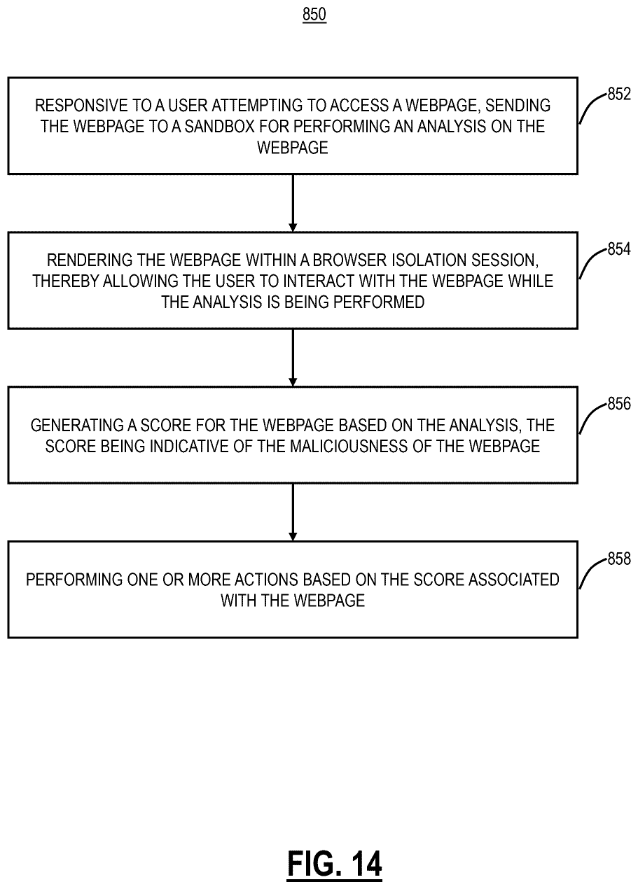

FIG. 14 is a flowchart of a process for HTML sandboxing with browser isolation. The process 850 can be contemplated as a method having steps, a processing device configured to implement the steps, a cloud-based system configured to implement the steps, and as a non-transitory computer-readable medium storing instructions for programming one or more processors to execute the steps. The process 850 includes responsive to a user attempting to access a webpage, sending the webpage to a sandbox for performing an analysis on the webpage (step 852); rendering the webpage within a browser isolation session, thereby allowing the user to interact with the webpage while the analysis is being performed (step 854); generating a score for the webpage based on the analysis, the score being indicative of the maliciousness of the webpage (step 856); and performing one or more actions based on the score associated with the webpage (step 858).

The process 850 can further include responsive to the score indicating the webpage as being benign, the one or more actions can include ending the browser isolation session and providing the user with direct access to the webpage. Responsive to the score indicating the maliciousness of the webpage as being unknown, the one or more actions can include continuing the browser isolation session and performing additional analysis. Responsive to the score indicating the webpage as being malicious, the one or more actions can include ending the browser isolation session and blocking the webpage. The one or more actions can further include logging and labeling the webpage as being malicious for future reference. The analysis can include performing static and dynamic analysis on the webpage for determining the score while the user has access to the webpage via the browser isolation session. Sending the webpage to the sandbox and rendering the webpage within a browser isolation session can be performed concurrently.

### § 9.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 10.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
responsive to a user attempting to access a webpage, sending the webpage to a sandbox for performing an analysis on the webpage;
rendering the webpage within a browser isolation session, thereby allowing the user to interact with the webpage while the analysis is being performed;
generating a score for the webpage based on the analysis, the score being indicative of a maliciousness of the webpage; and
performing one or more actions based on the score associated with the webpage.

2. The method of claim 1, wherein responsive to the score indicating the webpage as being benign, the one or more actions include ending the browser isolation session and providing the user with direct access to the webpage.

3. The method of claim 1, wherein responsive to the score indicating the maliciousness of the webpage as being unknown, the one or more actions include continuing the browser isolation session and performing additional analysis.

4. The method of claim 1, wherein responsive to the score indicating the webpage as being malicious, the one or more actions include ending the browser isolation session and blocking the webpage.

5. The method of claim 4, wherein the one or more actions further include logging and labeling the webpage as being malicious for future reference.

6. The method of claim 1, wherein the analysis includes performing static and dynamic analysis on the webpage for determining the score while the user has access to the webpage via the browser isolation session.

7. The method of claim 1, wherein sending the webpage to the sandbox and rendering the webpage within a browser isolation session are performed concurrently.

8. A non-transitory computer-readable medium comprising instructions that, when executed, cause one or more processors to perform steps of:
responsive to a user attempting to access a webpage, sending the webpage to a sandbox for performing an analysis on the webpage;
rendering the webpage within a browser isolation session, thereby allowing the user to interact with the webpage while the analysis is being performed;
generating a score for the webpage based on the analysis, the score being indicative of a maliciousness of the webpage; and
performing one or more actions based on the score associated with the webpage.

9. The non-transitory computer-readable medium of claim 8, wherein responsive to the score indicating the webpage as being benign, the one or more actions include ending the browser isolation session and providing the user with direct access to the webpage.

10. The non-transitory computer-readable medium of claim 8, wherein responsive to the score indicating the maliciousness of the webpage as being unknown, the one or more actions include continuing the browser isolation session and performing additional analysis.

11. The non-transitory computer-readable medium of claim 8, wherein responsive to the score indicating the webpage as being malicious, the one or more actions include ending the browser isolation session and blocking the webpage.

12. The non-transitory computer-readable medium of claim 11, wherein the one or more actions further include logging and labeling the webpage as being malicious for future reference.

13. The non-transitory computer-readable medium of claim 8, wherein the analysis includes performing static and dynamic analysis on the webpage for determining the score while the user has access to the webpage via the browser isolation session.

14. The non-transitory computer-readable medium of claim 8, wherein sending the webpage to the sandbox and rendering the webpage within a browser isolation session are performed concurrently.

15. A cloud-based system comprising:
one or more processors; and
memory storing computer-executable instructions that, when executed, cause the one or more processors to:
responsive to a user attempting to access a webpage, send the webpage to a sandbox for performing an analysis on the webpage;
render the webpage within a browser isolation session, thereby allowing the user to interact with the webpage while the analysis is being performed;
generate a score for the webpage based on the analysis, the score being indicative of a maliciousness of the webpage; and
perform one or more actions based on the score associated with the webpage.

16. The cloud-based system of claim 15, wherein responsive to the score indicating the webpage as being benign, the one or more actions include ending the browser isolation session and providing the user with direct access to the webpage.

17. The cloud-based system of claim 15, wherein responsive to the score indicating the maliciousness of the webpage as being unknown, the one or more actions include continuing the browser isolation session and performing additional analysis.

18. The cloud-based system of claim 15, wherein responsive to the score indicating the webpage as being malicious, the one or more actions include ending the browser isolation session and blocking the webpage.

19. The cloud-based system of claim 18, wherein the one or more actions further include logging and labeling the webpage as being malicious for future reference.

20. The cloud-based system of claim 15, wherein the analysis includes performing static and dynamic analysis on the webpage for determining the score while the user has access to the webpage via the browser isolation session.
